(19) United States
(12) Patent Application Publication
(10) Pub. No.: US 2001/0002561 A1
(43) Pub. Date: Jun. 7, 2001

(54) WIRE SAW APPARATUS AND METHOD

(76) Inventors: MITSUHIRO SHIRAGA, YOKOHAMA-SHI (JP); YASUHIRO ITO, YOKOHAMA-SHI (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 09/085,551

(22) Filed: May 27, 1998

Related U.S. Application Data
(63) Continuation of application No. 08/654,405, filed on May 28, 1996, now abandoned.

(30) Foreign Application Priority Data
Sep. 30, 1994 (JP) 6-237574
Dec. 27, 1994 (JP) 6-325583
Mar. 31, 1995 (JP) 7-076295

(51) Int. Cl. B26D 1/547

(52) U.S. Cl. 83/13; 83/76.7

(57) ABSTRACT

An apparatus and method for cutting a workpiece with a wire saw. A frame is provided with a pair of reel bobbins. A strand of wire unwound from one of the reel bobbins is spirally wound about a pair of cutting rollers and is simultaneously wound about the other reel bobbin while causing the cutting rollers to rotate. A workpiece contacts the wire to cut the workpiece. The pair of reel bobbins are supported in a manner that their axes are vertical. The apparatus controls the tension in the wire and the speed of the wire. Also, excessive loosening of the wire is prevented with a brake device.

### CROSS-REFERENCES TO RELATED APPLICATIONS

This application is a continuation of U.S. application Ser. No. 08/654,405, filed on May 28, 1996, which was the national stage of international application no. PCT/JP95/02003, filed on Sep. 29, 1995. U.S. application Ser. No. 08/654,405 is incorporated herein by reference.

### BACKGROUND OF THE INVENTION

The present invention relates to wire saws used to cut materials such as semi-conducting material and magnetic material.

Typically, wire saws have a plurality of cutting rollers about which a single strand of wire is spirally wound a number of times. Rotation of the cutting rollers causes the wire to travel in its extended, or axial, direction. The moving wire is brought into contact with a workpiece. Slurry, which includes abrasive grains, is applied to the contact area. This slices the workpiece with the wire and simultaneously produces a plurality of wafers.

Such an apparatus is provided with a wire, the ends of which are wound about a pair of reel bobbins. The wire is unwound from one of the reel bobbins toward the cutting rollers, passes by the cutting rollers, and is wound about the other reel bobbin.

As described in U.S. Pat. No. 5,201,305 and Japanese Unexamined Patent Publication No. 1-295758, in the prior art, the pair of reel bobbins were each horizontally supported by a pair of bearings.

In recent years, the reserved wire length of the reel bobbins has become longer to perform continuous cutting over a long period of time and to increase the number of cut pieces per unit time by increasing the traveling velocity of the wire. This has resulted in enlargement of the reel bobbins and has thus increased the weight of the bobbins, which includes the weight of the wire.

Therefore, supporting the heavy reel bobbins in a horizontally cantilevered manner was difficult. Hence, since each reel bobbin was supported by a pair of bearings, a total number of four sets of bearings were required. This caused an increase in the number of parts and caused the structure to become complicated. In addition, the bearings, which were located on both ends of the reel bobbins, enlarged the reel mechanism. Furthermore, since it was necessary to accurately align the axes of the pair of bearings, the reel mechanism required components having high dimensional precision and also required accuracy during assembly. This increased manufacturing costs. When replacing the wire, it was necessary to lift, lower, and position the reel bobbin at a location between the pair of bearings with the bobbin held horizontally in order to align the bobbin with the bearings or to remove the bobbin from the bearings. This operation was thus burdensome.

Additionally, engagment of the spirally wound wire with flanges, which are formed on both ends of the reel bobbin, results in a pressing force acting on the flanges in the axial direction of the reel bobbin. This deforms of the reel bobbin's flanges. Deformation of the flanges hinders the bundle of the wire, which is defined about the body of the reel bobbin, from having an even width along the axial direction of the bobbin and from, being arranged in an even manner. It also causes the wire wound onto the bundle to press into the wire of the bundle. As a result, during unwinding of the wire, fluctuation in the wire's tension leads to a reduction in the cutting accuracy of the wire or a rupture of the wire due to excessive tension.

Furthermore, when the reel bobbin is supported horizontally, the body of the reel bobbin is deflected downward by its own weight and by the wire's weight. This also impedes the wire from being wound in an even manner. Increasing the strength of the reel bobbin to cope with this problem increases the weight of the bobbin itself. This also calls for larger bearings that support the reel bobbins and a larger motor that rotates the reel bobbin. This enlarges the peripheral mechanisms of the reel bobbin.

### SUMMARY OF THE INVENTION

It is an objective of the present invention to provide a wire saw capable of reducing the number of bearings to simplify the retaining structure of the reel bobbins while allowing facilitated aligning of the bearings that support the reel bobbins to reduce the production cost of the apparatus and simplify its assembly.

Another objective of the present invention is to provide a wire saw capable of preventing deformation or damage of the reel bobbin's flange and curving of the bobbin's body while allowing the wire to be evenly and accurately wound about the bobbin.

It is also an objective of the present invention to provide a wire saw capable of preventing excessive loosening of the wire, which is caused by inertial rotation of the reel bobbin when the reel mechanism is stopped, and thus maintain appropriate winding of the wire with respect to the bobbin and allow smooth rotation when commencing rotation of the reel mechanism.

Another objective of the present invention is to provide a wire saw capable of controlling the rotation of each of the pair of reel bobbins at an appropriate rotating speed and thus allow smooth unwinding and winding of the wire.

A further objective of the present invention is to provide a wire saw capable of always maintaining constant tension of the traveling wire regardless of changes in the winding diameter of the wire wound about the pair of reel bobbins.

The gist of the present invention is a wire saw having a strand of wire that is unwound from one of the reel bobbins and wound about a plurality of cutting rollers, which constitute a cutting device, and is simultaneously wound about the other reel bobbin while rotating the cutting rollers and the pair of reel bobbins to cause the wire to travel. A cutting feed is applied to the wire and a workpiece in this state to cut the workpiece. The wire saw supports the pair of reel bobbins with rotary shafts in a manner such that its axes are oriented in a vertical direction.

Therefore, according to the present invention, it is unnecessary to provide a support device having bearings at the top of the reel bobbin. This allows a reduction in the number of bearings and simplifies the aligning of the bearing which supports the reel bobbin. It also facilitates the production and assembly of the apparatus.

In addition, according to the present invention, flanges of the reel bobbins are formed with a thicker width to tolerate expansion of the reel bobbin toward the axially top section of the reel bobbin. This prevents deformation and damage of the reel bobbin's flange. Furthermore, since the weight of the reel bobbins and the wire acts in a downward direction along the axes of the reel bobbins, curving of the bobbin's body is prevented and winding of the wire is performed evenly and accurately.

The present invention is also provided with a displacement member that is displaced as the tension of the wire changes and a sensor, which detects the position of the displacement member.

In the present invention, a braking device temporarily stops the rotation of the reel bobbin and sustains it in this state when the sensor detects the displacement member reaching a predetermined position located just before the lowermost position. By releasing the brake, the displacement member is moved to and stopped at the lowermost position.

Accordingly, excessive loosening of the wire, caused by inertial rotation of the reel bobbin when the bobbin is stopped, is absorbed when the displacement member is lowered and the winding of the wire, with respect to the bobbin, is thus maintained at an appropriate state. This allows smooth starting of the operation of the wire saw.

Additionally, the present invention is provided with a controlling device which controls the rotating speed of the reel motor in accordance with changes in the winding diameter of the wire, wound about the reel bobbins.

Therefore, the tension of the traveling wire is maintained constant regardless of changes in the winding diameter of the wire wound about the reel bobbins. This contributes to a stable cutting quality.

Basically, the invention is a wire saw for cutting a workpiece by moving the wire lengthwise, the saw includes a first reel bobbin having an axis of rotation and a second reel bobbin having an axis of rotation. Further included is a strand of wire connected to the bobbins, wherein the wire is wrapped about the first bobbin and is connected to the second bobbin such that the wire is unwound from the first bobbin and is wound about the second bobbin. A plurality of cutting rollers about which the wire is wrapped are provided. Further included is a bobbin support for supporting each bobbin such that each bobbin is rotatable about its axis and such that the weight of each bobbin acts only in the axial direction.

The invention further includes a method for controlling the wire saw including the steps of: arranging the axes of the bobbins such that the weight of the bobbins and the wire wound thereon acts in the axial direction of each bobbin; and guiding the wire as it is wound onto the second bobbin to cause the wire to be wound uniformly with a traverser that reverses to move back and forth between reversing positions in the axial direction of the second bobbin in correspondence with a program.

The invention further includes a method for controlling the wire saw including the step of arranging the axes of the bobbins such that the weight of the bobbins and the wire wound thereon acts in the axial direction of each bobbin.

### BRIEF DESCRIPTION OF THE DRAWINGS

FIG. 1 is a front view showing a wire saw entirely.

FIG. 2 is a plan view showing the wire saw entirely.

FIG. 3 is a graph showing the traveling direction and the traveling velocity of the wire.

FIG. 4 is a partial front view showing a reel device.

FIG. 5 is a plan view showing the reel device.

FIG. 6 is a partial side view showing the reel device.

FIG. 7 is a front view showing a tension applying device.

FIG. 8 is a cross-sectional view taken along line 8-8 in FIG. 7.

FIG. 9 is an enlarged cross-sectional view showing a strain gauge.

FIG. 10 is a block diagram illustrating the electrical structure of the wire saw.

FIG. 11 is a flowchart related to judgement of the remaining length of the wire.

FIG. 12 is a flowchart related to compensation of the reel bobbin rotation.

FIG. 13 is a graph illustrating the relationship between the wire traveling velocity and the reel winding diameter.

FIG. 14 is a flowchart illustrating the completion of operation.

FIG. 15 is a partial front view showing the reel device.

FIG. 16 is a flowchart illustrating reversing compensation of a traverser.

FIG. 17 is a flowchart illustrating the second embodiment.

FIG. 18 is a flowchart illustrating the third embodiment.

FIG. 19 is a cross-sectional view showing the wire winding state of the reel bobbin according to the third embodiment.

FIG. 20 is a front view of showing the dimensions of each section of the reel bobbin according to the third embodiment.

FIG. 21 is a cross-sectional view showing the wire winding state of the reel bobbin according to the third embodiment.

FIG. 22 is a cross-sectional view showing the wire winding state of the reel bobbin according to the third embodiment.

### DETAILED DESCRIPTION OF THE PREFERRED EMBODIMENTS

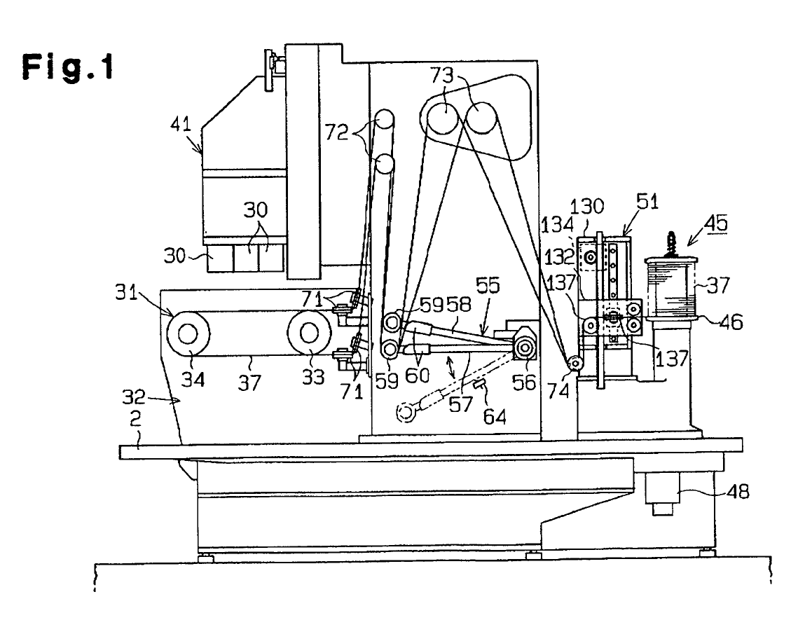

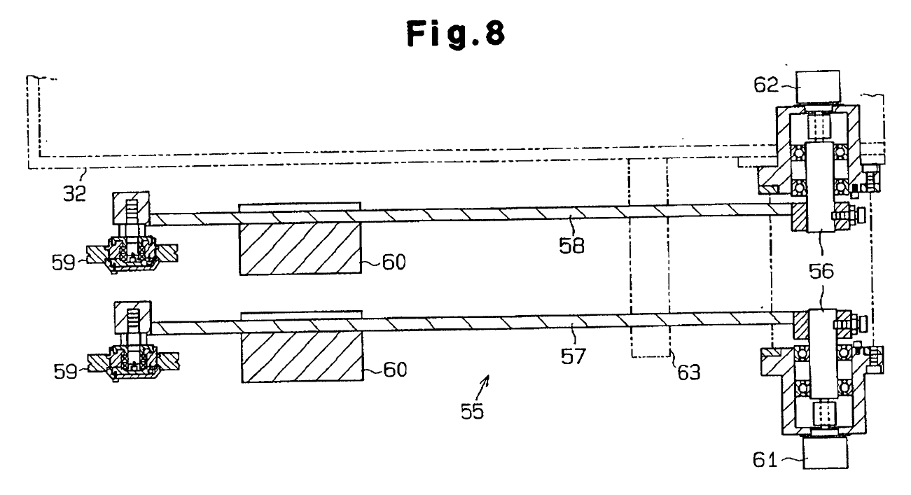

A first embodiment according to the present invention will hereafter be described with reference to FIGS. 1 through 16.

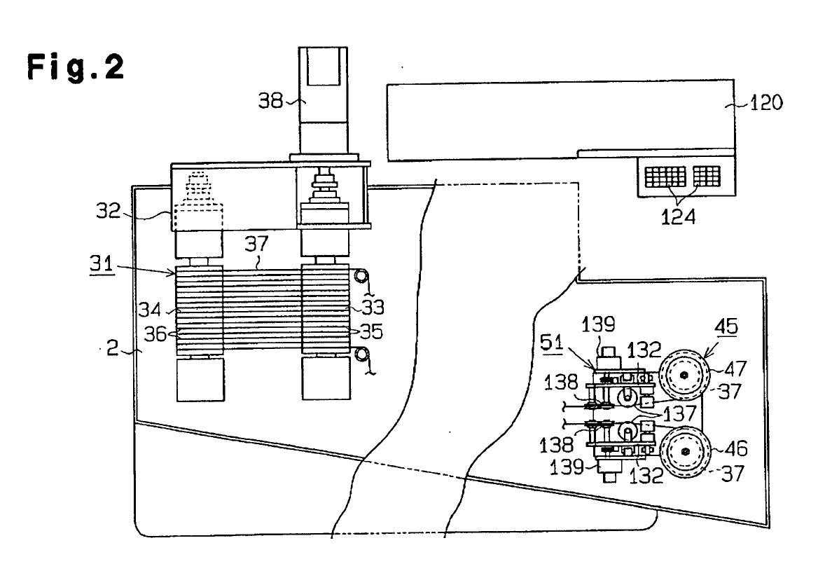

As shown in FIGS. 1 and 2, a cutting device 31 is provided on a machine plate 32, which is mounted on a bed 2. The cutting device 31 includes a drive roller 33 and a driven roller 34, which extend parallel to each other and serve as cutting rollers. A plurality of parallel annular grooves 35, 36 are formed on the peripheral surface of the drive roller 33 and driven roller 34, respectively. The pitch of the grooves 35, 36 is exaggerated in the drawings to facilitate understanding. However, the grooves 35, 36 are actually arranged with a pitch in the range of 0.3 millimeters to a few millimeters. The pitch of the grooves 35, 36 is selected in accordance with the cutting conditions.

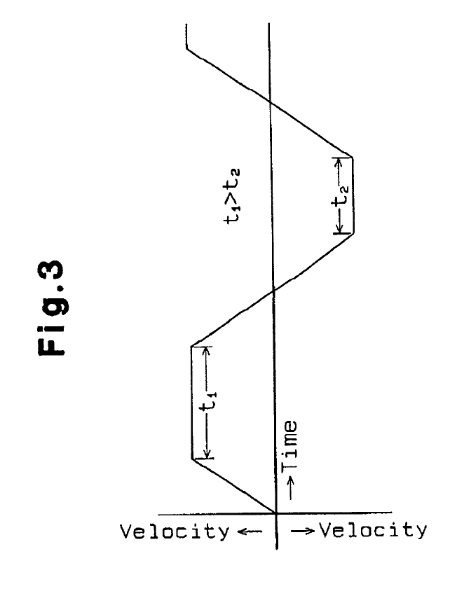

A single strand of cutting wire 37 is spirally and continuously wound about the grooves 35, 36 of the associated rollers 33, 34. A motor 38, which is capable of rotating in the forward and the reverse direction, is provided on the machine frame 32. The motor 38 rotates the drive roller 33. By driving the drive roller 33, the wire 37 travels in its axial direction. As shown in FIG. 3, when the rotation of the motor 38 is reversed, the traveling time t1 of the wire 37 traveling in one direction is longer than the traveling time t3 of the wire 37 traveling in the opposite direction. Accordingly, the wire 37 gradually advances in a predetermined direction as the traveling direction of the wire 37 is periodically reversed.

A workpiece supporting device 41 is supported by the frame 32 above the cutting device 31 such that it is capable of moving upward and downward. A plurality of workpieces 30 are set at the lower section of the supporting device 41. The workpiece supporting device 41 is lowered toward the cutting device 31 when the wire 37 travels between the rollers 33, 34 of the cutting device 31. Simultaneously, a slurry supplying device, which is not shown, supplies slurry that includes abrasive grains to the wire 37. The workpieces 30 are pressed against the wire 37 and sliced by the lapping action of the abrasive grains.

As shown in FIGS. 1, 2 and FIGS. 4 to 6, a reel device 45 is mounted on the frame 32. The reel device 45 is provided with first and second reel bobbins 46, 47. The wire 37 is wound on either the first reel bobbin 46 or the second reel bobbin 47 and is unwound from either the second reel bobbin 47 or the first reel bobbin 46 as the wire 37 travels. The rotating direction of first and second motors 48, 49, which are servo motors, are switched periodically as shown in FIG. 3. The first reel bobbin 46 and the second reel bobbin 47 are rotated by the motors 48, 49, respectively. Just before the wire 37 on the first or second reel bobbin 46, 47 is completely wound on the second reel bobbin 47 or the first reel bobbin 46, the rotating direction of both reel bobbins 46, 47 is switched. This switches the unwinding function and winding function of the reel bobbins 46, 47.

A traversing device 51 is mounted on the frame 32, adjacent to the reel device 45, and is provided with a traverser 143. The traverser 143 guides both the unwinding of the wire 37 from either the first reel bobbin 46 or the second reel bobbin 47 and the winding of the wire 37 about either the second reel bobbin 47 or the first reel bobbin 46 as it is traversed upward or downward.

As shown in FIGS. 1, 2, 7, and 8, a tension applying device 55 is arranged between the reel device 45 and the cutting device 31 to apply tension to the wire 37. The tension device 55 has a pair of shafts 56, which are rotatably supported by the frame, and a pair of dancer arms 57, 58, each of which are fixed to one of the shafts 56. Guide rollers 59 and weights 60 are attached to the distal section of both dancer arms 57, 58. The dancer arms 57, 58 and the guide rollers 59 constitute a displacement device. A pair of sensors 61, 62, which are composed of encoders and connected to each shaft 56, detects the rotation of the shafts 56 and transmit a detection signal, which corresponds to the pivoting position of the dancer arms 57, 58. A stopper 63 projects from the front surface of the frame 32. The lowermost position of the dancer arms 57, 58 are restricted by the engagement with the stopper 63. A limit switch 64 transmits detection signals when the dancer arms 57, 58 are positioned at the lowermost position. When the detection signal is transmitted from the limit switch 64, the operation of the wire saw is stopped.

As shown in FIGS. 1 and 2, guide rollers 71, 72, 73, 74 are arranged between the cutting device 31 and the tension device 55 and between the tension device 55 and the reel device 45 to guide the traveling wire 37. The wire 37 unwound from either the first or the second reel bobbin 46, 47 reaches the cutting device 31 by way of one of the guide rollers 74, one of the guide rollers 73, one of the rollers 59 of the tension device 55, one of the guide rollers 72, and one set of the guide rollers 71. From the cutting device 31, the wire 37 is wound about either the second or the first reel bobbin 47, 46 by way of the other set of guide rollers 71, the other guide roller 72, the other roller 59 of the tension device 55, and the other guide rollers 73, 74. The weight 60 provided on the dancer arms 57, 58 of the tension device 55 applies a predetermined tension to the full length of the wire 37 including the wire 37 between the rollers 33, 34.

Reel Device

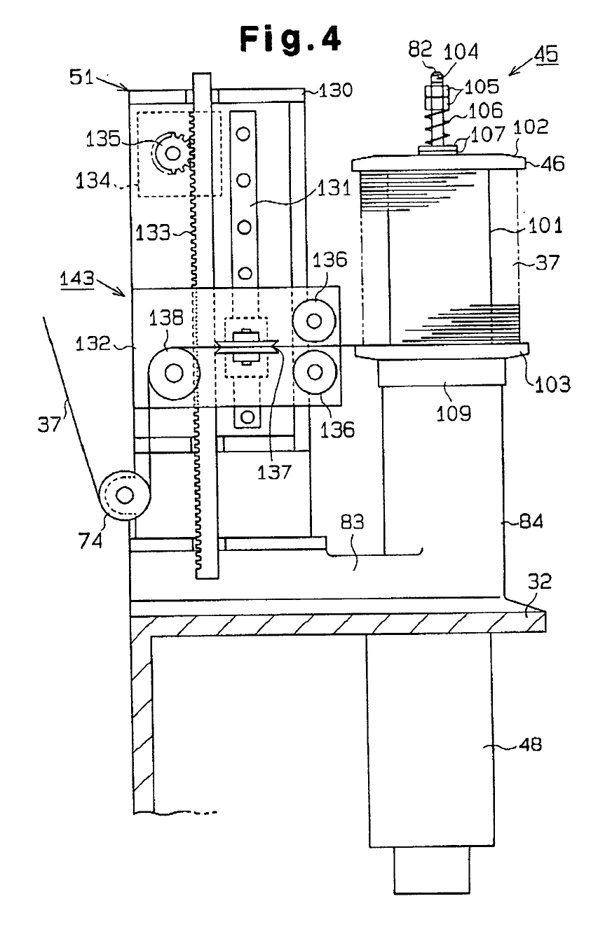

As shown in FIGS. 4 to 6 and 9, the first and second motors 48, 49, the rotating direction and rotating speed of which are variable, are connected to cylindrical bodies 84, which are mounted on the bed 2. Motor shafts 85, 86 project from the upper surface of the motors 48, 49, respectively. Rotary shafts 87 are rotatably supported by upper bearings 88 and lower bearings 89, which receive load in the axial direction and the radial direction, in the cylindrical bodies 84. A flange 91 is formed integrally with the upper end of each rotary shaft 87. Couplings 92 connect the motor shafts 85, 86 with each rotary shafts 87.

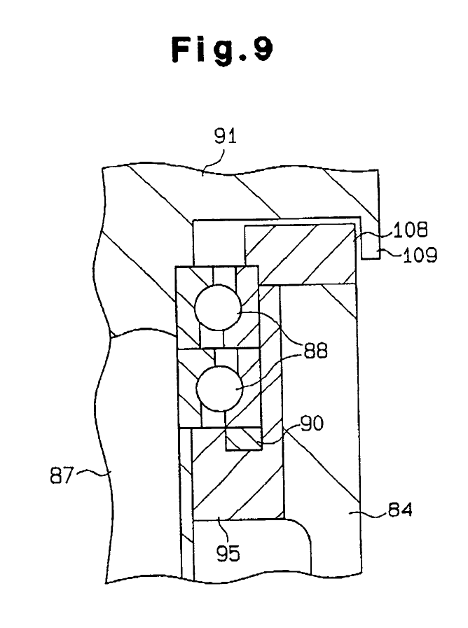

As shown in FIG. 9, a strain gauge 90 is retained in each cylindrical body 84 so that it contacts the lower surface of the outer race of the upper bearing 88. The gauge 90 detects the axial load of the associated rotary shaft 87, which is produced by the weight of the associated reel bobbin 46,47.

The first reel bobbin 46 and the second reel bobbin 47 are arranged on the flange 91 of the associated rotary shaft 87, and are restricted from rotating with respect to the flange 91 by pins 94. The first reel bobbin 46 and the second reel bobbin 47 are arranged in a manner such that their axes M1, M2 extend vertically. Rods 82 are provided at the center of the flange 91 with double nuts 105 fastened to a threaded section 104, which is defined at their upper ends. Coil springs 106, which serve as an elastic member, are located between the double nuts 105 and two plate-like rings 107, which are provided on the upper surface of the first and second reel bobbins 46, 47. The springs 106 press the reel bobbins 46, 47 against the upper surface of the flanges 91.

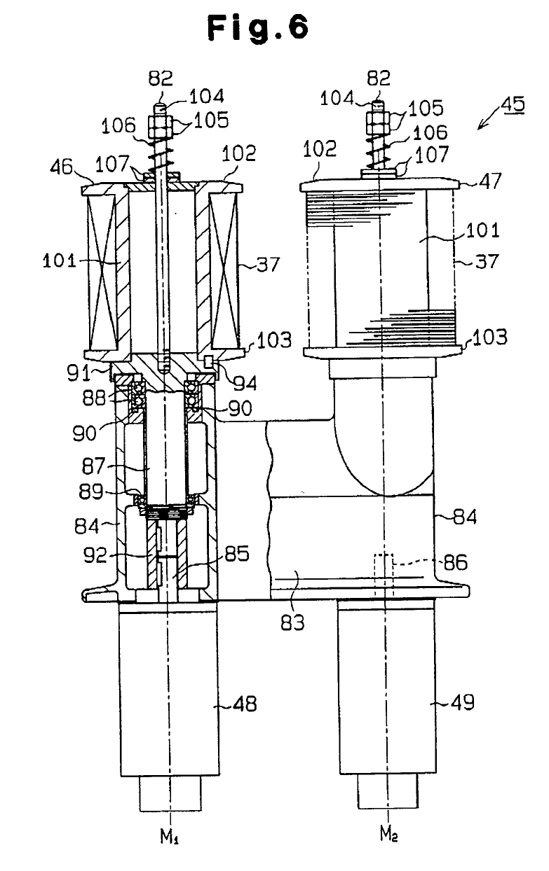

As shown in FIG. 6, the reel bobbins 46, 47 each have a body 101 and a pair of flanges 102, 103, which are formed integrally from aluminum alloy.

A seal 108, shown in FIG. 9, is located between the top surface of each cylindrical body 84 and the lower surface of the flange 91. A cylindrical skirt 109 is formed integrally with the lower peripheral section of each flange 91 in a manner such that it encompasses the peripheral surface of the seal 108. The skirt 109 prevents slurry from entering through the side of the upper bearings 88 and increases the durability of the upper bearings 88.

As shown in FIG. 1, the reel bobbins 46, 47 are supported by the associated rotary shafts 87 such that their associated axes M1, M2 are vertical. In other words, the reel bobbins 46, 47 are arranged on the flange 91 of the associated rotary shaft 87 so that they extend in the vertical direction. Accordingly, only a total of two sets of the bearings 88, 89, which support the reel bobbins 46, 47, are required to be provided below the reel bobbins 46, 47. This reduces the required number of bearings and simplifies the structure. It also facilitates production.

Since bearings are provided on only one end of the reel bobbins 46, 47 and are not required on both ends, the alignment of the bearing is simplified and thus the production and assembly of the apparatus is facilitated.

Since the reel bobbins 46, 47 have upper ends that are free and are pressed only by the springs 106, the body 101 of the reel bobbins 46, 47 is expansible in the axial upward direction when wire winding pressure is applied. In this case, it is preferable that the flanges 102, 103 be thicker to increase their strength. Hence, when the body 101 expands axially due to the winding pressure of the wire 37 and heat deformation, outward pressure caused by the bundle of the wire is not applied to the flanges 102, 103 in a concentrated manner. Therefore, deformation of the flanges 102, 103 is prevented, and even winding of the wire about the reel bobbins 46, 47 becomes possible. As a result, the tension of the wire 37 is stabilized during unwinding. This contributes to high precision cutting.

In addition, since the reel bobbins 46, 47 are supported so that they are vertical, bending load, which is produced by the weight of the reel bobbins 46, 47 and the wire 37 and which would otherwise act on the bodies 101 of the reel bobbins 46, 47 in a direction perpendicular to their axes, is suppressed. This maintains the body 101 in a straight cylindrical state and allows accurate winding of the wire 37. Furthermore, since bending load acting in the lateral direction of the body 101 need not be taken into consideration, the reel bobbins 46, 47 do not require great strength as in the prior art. This allows weight reduction of the reel bobbins 46, 47.

The reel bobbins 46, 47 are easily mounted on the rotary shafts 87 through a simple procedure of lowering the reel bobbins 46, 47 so that the rods 82 extend therethrough, placing the bottom of the reel bobbins 46, 47 on the flanges 91, and fastening the double nuts 105. The removal of the reel bobbins 46, 47 from the rotary shaft 87 is performed by reversing this procedure, and is thus simple.

Furthermore, since the reel bobbins 46, 47 are oriented vertically, the dimensions of the reel device in the lateral direction may be reduced. Additionally, since the bearings 88, 89, or load supporting devices, are required to be provided only under the reel bobbins 47, 48, it is possible to reduce the size of the entire reel device 45. Accordingly, this reduces the size of the entire wire saw.

The body 101 and the pair of flanges 102, 103 of the reel bobbins 46, 47 are formed integrally from an aluminum alloy. Accordingly, during the manufacturing process of the reel bobbins 46, 47, assembly processes, in which the body 101 and the flanges 102, 103 are assembled to each other, are not required and thus manufacturing is simplified. In addition, since the body 101 and the flanges 102, 103 are formed integrally, the strength of the entire reel bobbins 46, 47 is increased. This suppresses deformation of the reel bobbins 46, 47 caused when the wire 37 is wound. Therefore, the wire 37 is accurately wound about the reel bobbins 46, 47 without being disarranged. Furthermore, since the body 101 and the flanges 102, 103 are formed integrally, there is no possibility of deformation of the portions between the body 101 and the flanges 102, 103 caused by the wire 37 pressing into these portions, and the life of the reel bobbins 46, 47 may thus be prolonged.

Electrical Constitution

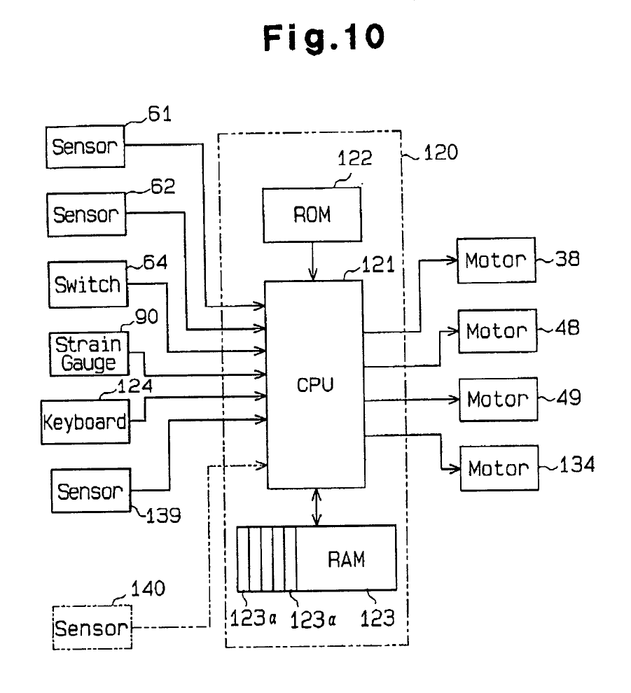

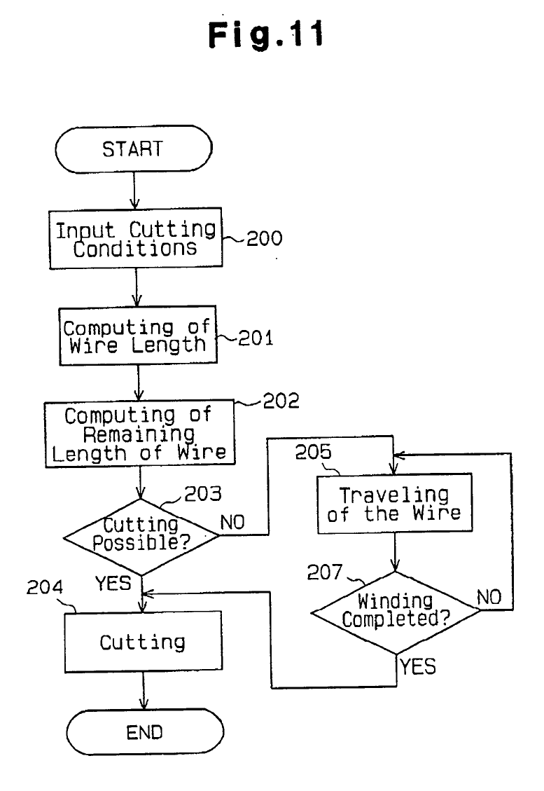

As shown in FIG. 10, a controlling device 120, located near the bed 2, is provided with a central processing unit (CPU) 121, a read-only memory (ROM) 122, and a random-access memory (RAM) 123. The CPU 121 controls the movements of the entire apparatus and also functions as a timer. The ROM 122 stores various programs to control the movements of the apparatus. The flowcharts illustrated in FIGS. 11, 12, 14, 16 show the processing controlled by the CPU 121 based on the programs in the ROM 122. The RAM 123 temporarily stores various data, such as input data and detection data. A plurality of memory areas 123α are provided in the RAM 123. A keyboard 124 is arranged in front of the controlling device 120. The data input by the keyboard 124 is stored in the memory area 123α of the RAM 123.

As shown in FIG. 10, the sensors 61, 62, the limit switch 64, the strain gauge 90, the keyboard 124, and the motors 38, 48, 49, 134 are linked to the CPU 121.

Processes Performed When Starting Cutting

As shown in FIG. 11, in step 200, cutting conditions, such as the type and size of the workpiece 30, the traveling velocity of the wire 37, and the winding diameter of the reel bobbins 46, 47 when starting the operation are input by an operator through the keyboard 124.

In step 201, the CPU 121 computes the length of the wire 37 that is required during the period from when cutting of the workpiece 30 is started until when the cutting is finished from various data such as the cutting speed per unit time of the workpiece 30, determined from the type, length, size, and shape of the workpiece 30, the length of time for completion of cutting determined from the cross-sectional shape of the workpiece 30, the traveling velocity of the wire 37, and the length of time for completion of cutting.

In step 202, the CPU 121 reads the detected data from the strain gauge 90 and computes the weight of the wire 37 on the reel bobbins 46, 47 from the data value.

The CPU 121 also calculates the length of the wound wire 37 on the reel bobbins 46 and 47 that is usable for the workpiece 30 from the computed weight of the wire 37 in step 202. Accordingly, a computing device that computes the length of the wound wire 37 is composed of the controlling device 120, which includes the CPU 121, the strain gauge 90, etc.

In step 203, the required length of the wire 37, computed in step 201, is compared with the length of the wound wire 37 computed in step 202. If the length of the wound wire 37 on the reel bobbin 46 or 47 is sufficient to complete cutting of the workpiece 30, in step 204, the workpiece supporting device 41 is lowered to contact the wire 37, and the wire 37 travels so as to start cutting of the workpiece 30.

However, if the length of the wound wire 37 on the reel bobbin 46 or 47 at the unwinding side is not sufficient to complete cutting of the workpiece 30, in steps 205, 206, the wire 37 of the first reel bobbin 46 or the second reel bobbin 47 travels without lowering the workpiece supporting device 41. After the wire 37 is completely wound about one of the reel bobbins 46 or 47, this reel bobbin 46 or 47 functions as the unwinding side, and cutting of the workpiece 30 is started. Accordingly, a judging device, which judges whether it is possible to cut the workpiece by comparing the length of the wound wire 37 with the required length of the wire, is composed of the controlling device 120. The length of the wound wire 37 may be determined by using the stored data of the unwound length of the wire used during the previous cutting.

Thus, the workpiece 30 is cut under stable conditions without interruptions that take place during cutting when the unwinding direction of the wire is switched due to the insufficiency of the wound length of the wire 37.

As described above, the reel bobbins 46, 47 are each supported by the rotary shafts 87 so that their axes M1, M2 are oriented in the vertical direction. This allows the weight of the reel bobbins 46, 47 to be measured by providing only a strain gauge 90, which is abutted against the bottom surface of the upper bearings 88, thus simplifying the structure.

Furthermore, the strain gauge 90 does not directly contact the reel bobbins 46, 47 and the rotary shafts 87. Therefore, the measuring of the weight of the reel bobbins 46, 47 is not influenced by the rotation of the reel bobbins 46, 47 and the rotary shafts 87.

Processes Performed for Rotation Compensation

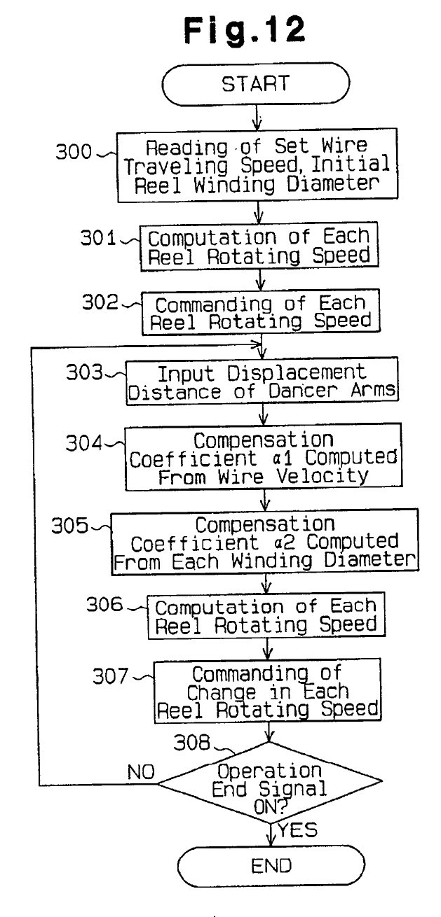

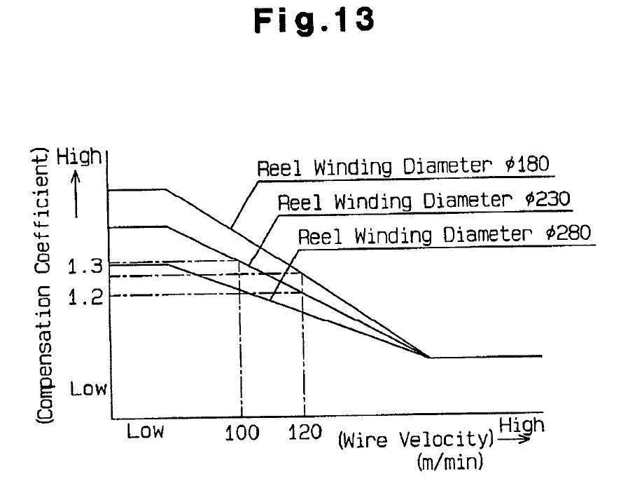

Compensation of the two reels' rotating speed in this embodiment will now be described with reference to FIGS. 12 and 13.

The theoretical rotating speed of the reel bobbins 46, 47 is constantly computed from the wire traveling velocity and the winding diameter of the reel. Additionally, the CPU 121 computes the compensating amount for the upward or downward movement of the dancer arms 57, 58. If there is no movement of the dancer arms 57, 58, the compensating amount is deemed to be zero, and the motors 48, 49 are rotated at the theoretical rotating speed. If movement of the dancer arms 57, 58 takes place, a compensating value is commuted from the compensation coefficient, which is computed from the present wire traveling velocity and the reel winding diameter. The compensated value is added to or subtracted from the theoretical rotating speed. This suppresses the upward or downward movement of the dancer arms 57, 58 and sustains a constant wire tension.

The compensating method is simply expressed by the following equations:

Reel Rotating Speed (N)=Theoretical Reel Rotating speed (N0)±Compensated Value (N1)

Theoretical Reel Rotating Speed (N0)=V/πD

Compensated Value (N1)=(V/πD)×(2L/πD)×α1×α2×k

V represents the wire traveling velocity, D represents the reel winding diameter, 2L represents the moving distance of the wire 37 that corresponds to the upward or downward movement distance from the neutral point of the dancer arms 57, 58, α1 represents the compensation coefficient used to alter the reel rotating speed computed from the wire traveling velocity, α2 represents the compensation coefficient used to alter the reel rotating speed computed from the reel winding diameter, and k represents a constant.

The operation illustrated in the flowchart of FIG. 12 will now be described. When the operation of the wire saw is commenced, in step 300, the CPU 121 reads the data of the traveling velocity V of the wire 37 and the initial winding diameter of each reel bobbin 46, 47 from the memory area 123α of the RAM 123. The data is input through a keyboard 124 and stored in the memory area 123α of the RAM 123. In step 301, the rotating speed of the reel bobbins 46, 47 are computed from the above equations. In step 302, the CPU 121 sends commands in correspondence with the computed results to the motors 39, 48, 49.

Afterwards, in step 303, the displacement amounts of the dancer arms 57, 58 are read based on the output from the sensors 61, 62.

In step 304, the compensation coefficient α1 based on the wire velocity is computed. In step 305, the compensation coefficient α2 based on each winding diameter of the reels is computed. Based on these coefficients, the rotating speed of the reel bobbins 46, 47 is computed through the above equations in step 306. In step 307, the CPU 121 sends commands in correspondence with the computed results to the motors 38, 48, 49.

As shown in FIG. 3, the wire 37 travels reciprocally while successively repeating speed increases and speed decreases to gradually advance the wire 37 in one direction. Since the wire traveling velocity is repetitively increased and decreased during operation, the data of the wire traveling velocity is also renewed simultaneously. The reel rotating speed is successively computed based on the renewed data. This is continued until an operation stop signal is output.

During cutting of the workpiece 30, predetermined tension is applied to the wire 37 between the cutting rollers 32, 33 by the weight 60 of each dancer arm 57, 58. The pivoting positions of the dancer arms 57, 58 are detected by the sensors 61, 62 and input into the CPU 121. The moving amount for each dancer arm 57, 58 is determined based on this data. The change in the tension of the wire 37 is detected from the movement of the dancer arms 57, 58.

The compensating value for the rotating speed of each reel rotating motor 48, 49 is computed separately to prevent movement of the dancer arms 57, 58 caused by the alteration in the speed of the motors 38, 48, 49, which is based on the detection data from the sensors 61, 62. As shown in FIG. 13, for example, in the case that the reel diameter is 230 mm, and the traveling velocity of the wire 37 is 120 m/min, the compensation coefficient is 1.2. In the case that the traveling velocity of the wire 37 is 100 m/min, the compensation coefficient is 1.3. If the reel diameter decreases when the wire traveling velocity is 120 m/min, the compensation coefficient becomes slightly smaller than 1.3. The compensation coefficient is multiplied with a predetermined compensation coefficient corresponding to the pivoting distance of the dancer arms 57, 58. The rotating speed of the reel motors 48, 49 is increased or decreased based on the multiplied results.

For example, if the first reel bobbin 46 corresponds to the winding side and the tension of the wire 37 on the winding side becomes excessive, the rotating speed of the motor 48, which rotates the first reel bobbin 46, is lowered. If the second reel bobbin 47 corresponds to the unwinding side and tension of the wire 37 on the unwinding side becomes excessive, the rotating speed of the reel motor 49 for the second reel bobbin 47 is raised. When the wire traveling velocity decreases or when the reel diameter becomes smaller, the compensation coefficient becomes larger and compensation is immediately performed. On the other hand, if the wire traveling velocity is increased or if the reel diameter becomes larger, the compensation coefficient becomes smaller and the compensating amount of both reel motors 48, 49 is reduced. This suppresses hunting of the dancer arms 57, 58.

Furthermore, due to the alteration of the motor rotating speed, judgement of whether the movement or the dancer arms 57, 58 has stopped, which is based on the output from the sensors 61, 62, is performed once again. If the movement has not stopped, the alteration is performed once more.

Accordingly, a compensating device, which alters the rotating speed of the reel motors 48, 49 in accordance with the detection data from the sensors 61, 62, is composed of the controlling device 120. An altering device, which alters the compensation coefficient for alteration of the rotating speed of the reel motors 48, 49 in accordance with the winding diameter of the reel bobbins 46, 47, is also composed of the controlling device 120. Furthermore, a first altering device, which alters the compensation coefficient for alteration of the rotating speed of the reel motors 48, 49 in accordance with the traveling velocity of the wire 37, is composed of the controlling device 120. A second altering device, which alters the same compensation coefficient in accordance with the winding diameter of the reel bobbins 46, 47, is also composed of the controlling device 120.

As described above, when the traveling velocity of the wire 37 is altered or when the winding diameter of the reel bobbins 46, 47 is varied, it is possible to compensate the rotating speed of the reel rotating motors 48, 49 immediately and accurately to end the fluctuation of the tension in the wire 37 that causes hunting. Thus, the tension of the wire 37 is always maintained at a predetermined value. This enables appropriate cutting. Additionally, since the tension fluctuation is ended immediately, it is possible for the dancer arms 57, 58 to have a shorter pivoting stroke. This contributes to the manufacturing of a compact wire saw with pivoting dancer arms 57, 58.

In addition, arbitrary setting of the data required to calculate the compensation coefficients is possible in this wire saw. This allows optimal compensation coefficients, which correspond to the cutting conditions of the type of workpiece 30, to be obtained. Therefore, an accurate wire tension is always obtained. This contributes to precision cutting of the wafers.

Processes Performed When Operation is Stopped

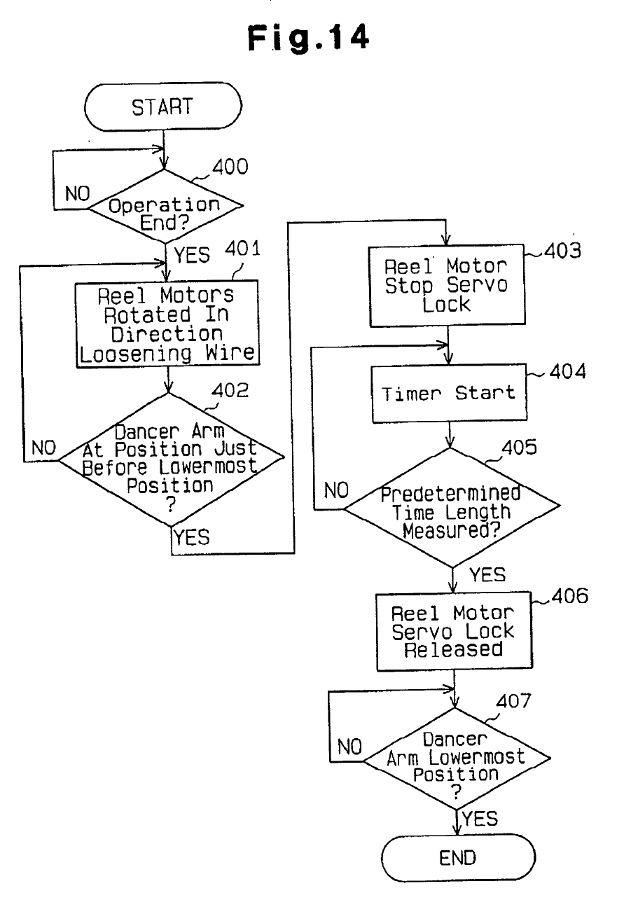

The processes which are performed when operation of the wire saw is stopped will now be described with reference to the flowchart of FIG. 14.

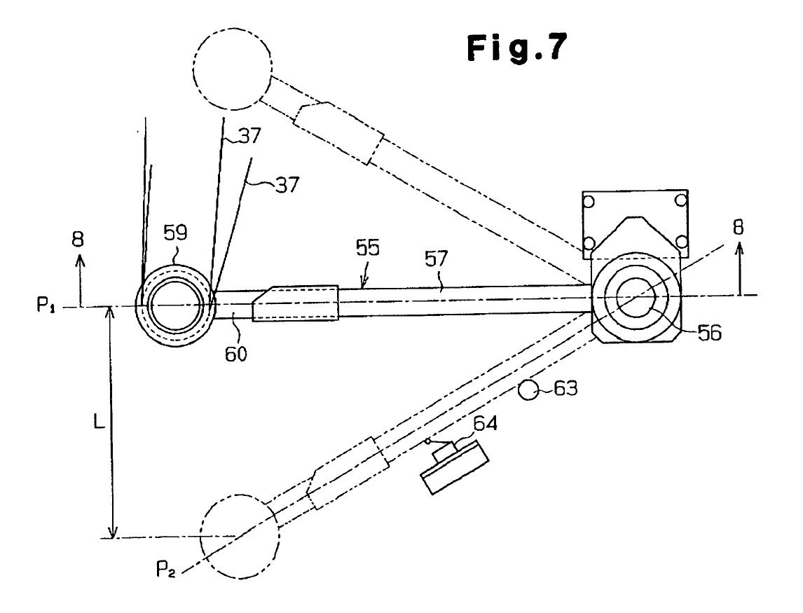

In step 400, an operation ending command is input into the CPU 121 by manipulation of the keys on the keyboard 121 or by the automatic stopping command in a program. In steps 401, 402, the reel rotating motors 48, 49 are slowly rotated in the direction that loosens the wire 37. This causes the dancer arms 57, 58 to be moved from the neutral position P1 toward the lowermost position P2, as shown in FIG. 7.

When the dancer arms 57, 58 are pivoted until they reach a predetermined position just before (a few millimeters above) the lowermost position, the reel rotating motors 48, 49 are stopped based on the detection signals of the sensors 61, 62 and braked in a servo lock state in step 403. Therefore, the dancer arms 57, 58 are stopped at the predetermined position. Accordingly, a braking device, which brakes the dancer arms 57, 58 is composed of the sensors 61, 62 and the controlling device 120.

The output from the sensors 61, 62 of the associated dancer arms 57, 58 is constantly input into the CPU 121. Thus, the position of the dancer arms 57, 58 is constantly detected. Accordingly, the CPU 121 computes the pivoting distance of the dancer arms 57, 58 from the neutral position P1 to the position just before the lowermost position P2 in correspondence with the operation ending command. Based on the computed result, the rotation of the motors 48, 49 is adjusted to unwind a required length of the wire 37.

Afterwards, in steps 404, 405, the timer starts measuring time and continues the servo lock state for a predetermined time period (1 to 2 seconds). Therefore, if vibrations, such as bounding caused by stopping of the dancer arms 57, 58, are produced in the dancer arms 57, 58, the vibrations are ended within the predetermined time period. After the timer measures the predetermined time length, in step 406, the motors 48, 49 are released from the servo lock state and become free. This enables the wire 37 to be unwound and thus slightly pivots the dancer arms 57, 58 from the position just before the lowermost position P2 to the lowermost position P2. After step 407, the dancer arms 57, 58 are stopped by the stopper 63.

As a result, excessive loosening of the wire 37 is prevented since the wire is not excessively loosened from the reel bobbins 46, 47 by the inertial rotation of the reel bobbins 46, 47 when operation of the apparatus is stopped. Hence, when operation of the wire saw is subsequently commenced, the wire 37 may smoothly travel without falling off the guide rollers 59, 71.

Since there is no excessive loosening of the wire 37 when operation is commenced, the dancer arms 57, 58 are readily returned to the neutral position P1 from the lowermost position P2 by winding the wire 37 about the reel bobbins 46, 47 for a predetermined length. Thus operation of the apparatus is commenced immediately.

The Traversing Device

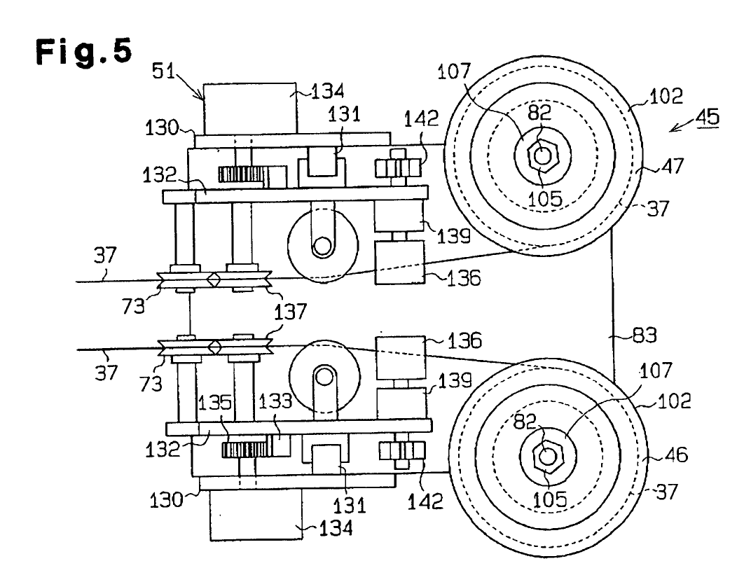

The traversing device 51 will now be described with reference to FIGS. 4 and 5.

A pair of stands 130, each of which is provided with a guide rail 131 extending vertically along its inner surface, is mounted on the frame 32 with a predetermined space in between. A pair of roving plates 132, each of which is supported by one of the guide rails 131, is movable in the upper and lower directions. A rack 133, extending vertically, is fixed to the outer surface of the plates 132. Each of a pair of traverse motors 134 is secured to the outer surface of one of the stands 130. Each motor 134 has a pinion 135, which is meshed with one of the the racks 133, fixed to its motor shaft.

When the traverse motors 134 are rotated, each of the moving plates 132 move in a traverse manner in the axial direction of the first reel bobbin 46 and the second reel bobbin 47 along the peripheral surface of the reel bobbins 46, 47. This causes the wire 37 to be unwound from one of the reel bobbins 46 or 47 while being traversed and wound about the other reel bobbin 47 or 46 while being traversed.

A pair of rotatable touch rollers 136 are arranged adjacent to each other and located one above the other with a predetermined space therebetween on each moving plate 132. The wire 37 passes through the space between the touch rollers 136. Guide rollers 137, 138 are rotatably supported by each moving plate 132 to guide the traveling of the wire 37.

Sensors 139 composed of encoders are connected to the shaft of the touch rollers 136 and detect the rotation of the touch rollers 136. If the wire 37 contacts the upper or lower roller 136 due to an inclination in the direction of the wire when it travels, the touch roller 136 is rotated and detected by the sensor 139. When rotation of the front touch roller 136, with respect to the traversing direction, is detected, it is judged that the traverse speed of the moving plate 132 is slow and the rotating speed of the motor 134 is thus increased. When rotation of the touch roller 136 located at the rear side with respect to the traversing direction is detected, it is judged that the traverse speed of the moving plate 132 is fast and the rotating speed of the motor 134 is thus decreased or temporarily stopped. A fin 142 is connected to the shaft of each touch roller 136 and applies a braking force to the rotation of the touch rollers 136 through its air resistance. Therefore, the touch rollers 136 are prevented from being rotated when the wire 37 does not contact the touch rollers 136. This prevents mistaken detection by the sensors 139.

The traverser 143 is composed of various parts such as the moving plates 132, and the touch rollers 136 mounted on the moving plates 132.

The traverser 143 moves reciprocally between the ends of the body 101 of the reel bobbins 46, 47 in correspondence with the data stored in the controlling device 120 to guide the wire 37.

However, heat expansion and the winding pressure of the wire 37 causes the body 101 of the reel bobbins 46, 47 to be slightly expanded in the axial direction during operation of the wire saw. Thus, if the traverser 143 guides the wire 37 by moving reciprocally within a constant range, a gap equal to the expanded length of the body 42 of the reel bobbins 46, 47 is produced between the bundle of the wire 37 and the flanges 102, 103 of the reel bobbins 46, 47. This may cause scattering of the wire bundle.

To prevent this problem, it is required to wind the wire 37 while appropriately compensating the reciprocating distance, or the position where the traverser 143 is reversed. In the present embodiment, a compensating device, which compensates the reversing position of the traverser 143 is composed of the encoders, which serve as the sensors 139, and the controlling device 120.

Processes Performed For Compensation of Reversing Position

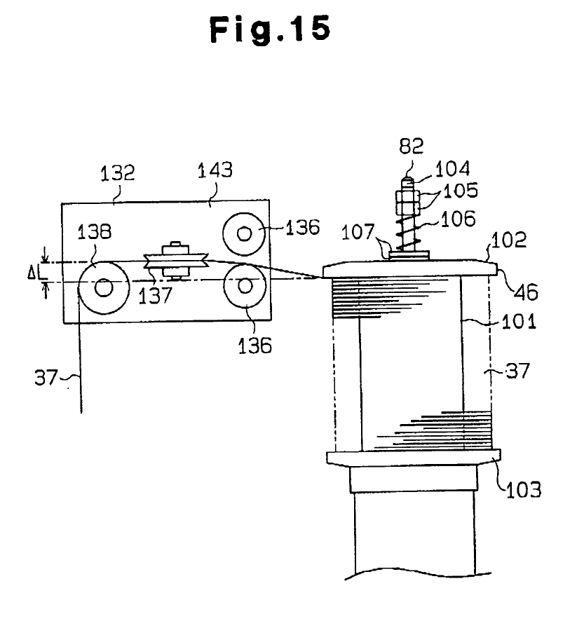

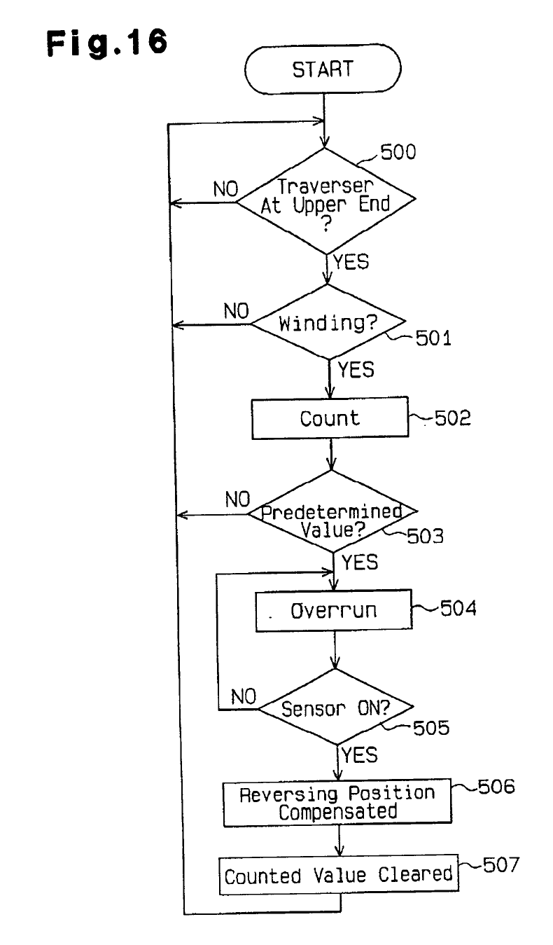

The reversing action of the traverser 143 will now be described with reference to FIGS. 15 and 16.

When the traverser 143 is detected being positioned at the upper end of the reciprocating movement range in step 500, it is judged whether the wire 37 is undergoing winding in step 501. Judgement of whether the traverser 143 has reached the upper end of the movement range is performed based on an initial input data of a prestored program.

In the case that the wire 37 is undergoing winding, the number of times which the upper end is reached is counted in step 502. This data is not counted when the wire 37 is not being wound, that is, when the wire 37 is being unwound.

In step 503, it is judged whether the value counted in step 502 has reached a predetermined value. If the counted value has reached the predetermined value, for example “10”, the subsequent step 504 is executed. That is, if the traverser 143 reaches the upper end of the reciprocating movement range during winding for ten times, in step 504, the traverser 143 slightly overruns the movement range as shown in FIG. 15.

Accordingly, as shown in FIG. 15, the wire 37 is extended along the inner surface of the upper flange 102 of the reel bobbins 46, 47 and then extended inclined from the outer rim of the flange 102. Thus, the wire 37 comes into contact with the touch roller 136. In step 505, the position of the traverser 143 with respect to the timing of the rotating signal, detected by the sensor 139, is memorized. When rotation is detected by the sensor 139, the movement of the traverser 143 is immediately reversed. In step 506, the subsequent upper reversing position is compensated by a predetermined distance ΔL from the position where rotation was detected to a position moved back toward the reel bobbins 46, 47.

Afterwards, in step 507, the value counted in step 502 is cleared. The processing then returns to step 500.

As described above, the upper reversing position is compensated by just having the traverser 143 overrun the upper end of the reel bobbins 46, 47, for example, once every ten rounds, and then detecting the position of the traverser 143 with the sensor 139 when the wire 37 contacts the touch roller 136 and starts rotating it.

In the present embodiment, the compensation of the reversing position is performed only at the upper side of the reel bobbins 46, 47 since the lower end of each reel bobbin 46, 47 is mounted on the flange 91 of the rotary shaft 87 and the reel bobbins 46, 47 thus expand at the upper side.

This enables the wire 37 to be wound substantially in an even manner and lowers the possibility of the wire 37 spreading when being wound.

Since the reversing position is compensated, for example, once every ten rounds, the wire 37 is not wound in a concentrated manner near the upper end of the body 101 of the reel bobbins 46, 47. It is preferable that the compensating frequency be determined by taking into consideration conditions such as the winding diameter of the reel bobbins 46, 47.

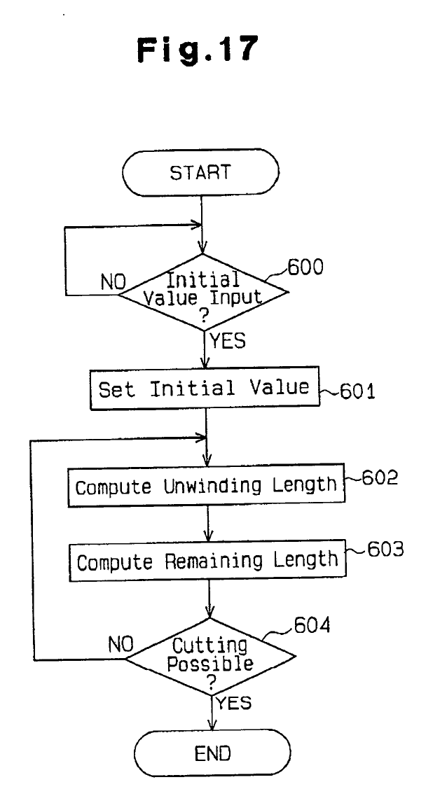

A second embodiment of the present invention will now be described with reference to FIG. 17. The flowchart shown in FIG. 17 is carried out by the CPU 121 based on the program set in the ROM 122 and the various data stored in the RAM 123 in the controlling device 120.

In the second embodiment, the structure of the detecting device that detects the wound length of the wire 37 on the reel bobbins 46, 47 at the unwinding side differs from that of the first embodiment. The wound length of the wire 37 is detected without relying on the detection of the weight of the reel bobbins 46, 47.

At steps 600, 601, the initial value of the length of the wound wire 37 on the reel bobbins 46, 47 is input by the keyboard 124 when replacing the reel bobbins 46, 47. In step 602, the unwinding speed, the unwinding direction, and the unwinding time (cutting time) of the wire 37 is computed from control data such as the rotating speed of the reel bobbin motors 48, 49 to further compute the unwound length of the wire 37. In step 603, the wound length of the wire 37 on the reel bobbins 46, 47 is computed by subtracting the unwound length of the wire 37 from the initial value at points in time.

The data of the time required to cut the workpiece 30 in accordance with its type and size, or the time period from when cutting is started to when cutting is completed, is stored in the RAM 123.

At step 604, it is determined whether it is possible to perform cutting when commencing cutting based on the data in the RAM 123 and the data of the wound length of the wire 37 on the reel bobbins 46, 47.

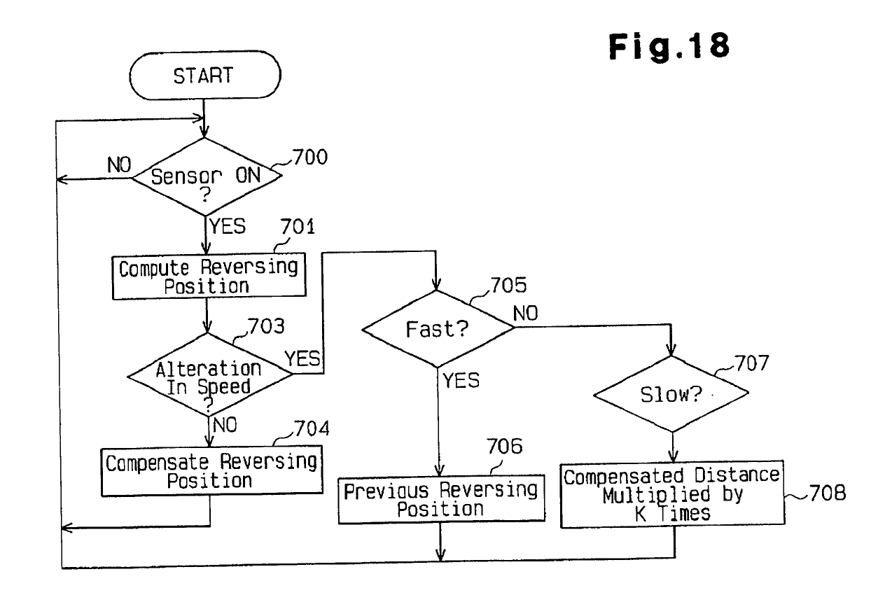

A third embodiment of the present invention according to the present invention will now be described with reference to FIGS. 18 through 22 will now be described. In this embodiment, the structure of the reversing position compensating device differs from the first and second embodiments.

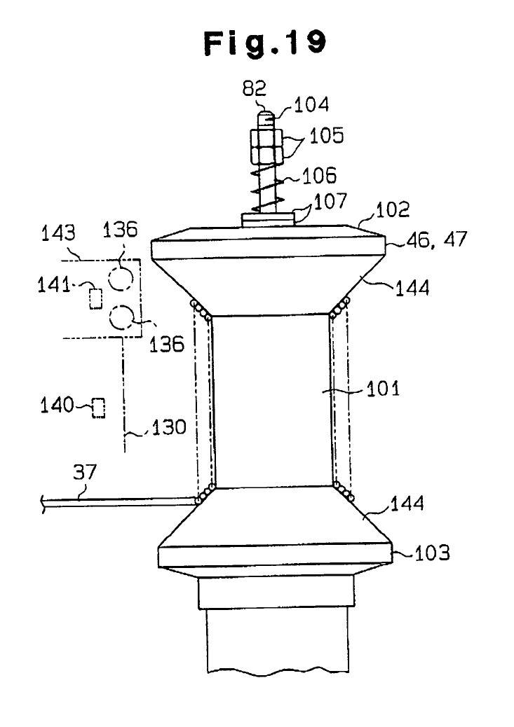

The flowchart shown in FIG. 18 is carried out by the CPU 121 based on the program set in the ROM 122 and the various data stored in the RAM 123 in the controlling device 120. In FIGS. 19, 21, 22, the diameter of the wire 37 is illustrated larger than the actual diameter to facilitate understanding.

A magnetic sensor 140, serving as a position sensor, is provided on each stand 130 at a location corresponding to the middle of the reel bobbins 46, 47 in the axial direction. A magnet 141, which passes by the sensor 140, is fixed to both moving bodies 61.

The inner side of both flanges 102, 103 of the reel bobbins 46, 47 are formed in a tapered manner. Accordingly, in addition to the controlling of the normal traverse movement of the traverser 143, another type of controlling becomes necessary. In this embodiment, the angle of the tapered surface 144 of the flanges 102, 103 with respect to the reel axis is 45 degrees.

The method in which the wire 37 is wound to the tapered flanges 102, 103 in an even manner will now be described. The reciprocating movement of the traverser 143 is set so that it is symmetrical with respect to the middle of the predetermined wire winding area of the reel bobbins.

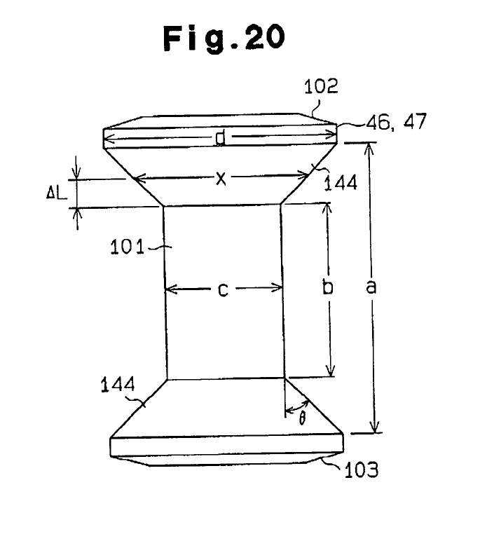

As shown in FIG. 20, the maximum winding width of the reel bobbins 46, 47 is represented by a, the minimum winding width is represented by b, the maximum shaft diameter is represented by d, and the minimum shaft diameter is represented by c.

As shown in FIG. 18, the winding of the wire 37 is first commenced, and then in step 700, it is judged whether the sensor 140 is in an activated state. When it is determined to be in an activated state, that is, when the traverser 143 is located at the substantially middle section of the wire winding area, the reversing position compensating distance ΔL is computed in accordance with the present winding diameter x in step 701. The traverse compensating distance is expressed in the following equation, which corresponds to FIG. 20:

ΔL=(x−c)/2·tan θ

Theta (θ) represents the angle defined by the tapered surface 144 and the reel axis.

In this embodiment, since θ=45°, ΔL=(x−c)/2.

That is to say, due to the winding diameter x being equal to the minimum winding diameter when winding is started, ΔL is zero. Accordingly, compensation of the reversing position is not conducted and reciprocation is thus performed between the reel bobbin's minimum winding width, which is an initial value. The winding diameter x is computed from, for example, the program data related to the rotating speed of the reel bobbins and the signals from the sensors 61, 62 of the associated dancer arms 57, 58. When the winding diameter becomes equal to or larger than a predetermined value, the reversing positions of the traverser 143 are each compensated toward the ends of the reel bobbins by adding ΔL=(x−c)/2, or half of the increased winding diameter.

In this manner, when the winding diameter at the ends of the reel bobbins 46, 47 coincides with the winding diameter at the middle of the traverse movement, the reversing position of the traverser 143 are each extended from the ends of the body 101 toward the ends of the reel bobbin by ΔL in accordance with the increasing diameter of the tapered surface 144. Thus, the wire 37 is wound along the tapered surface 144 of the flanges 102, 103.

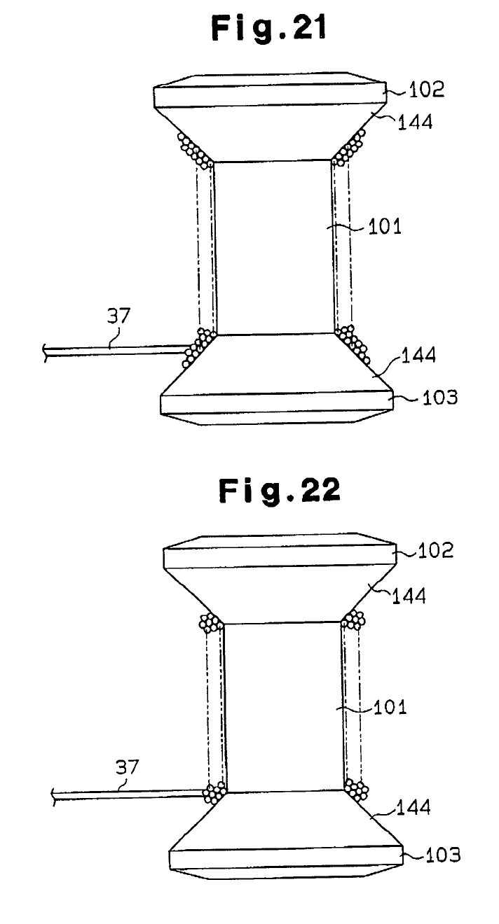

In step 703, it is judged whether there is alteration in the unwinding speed of the wire 37, produced by the rotation of the reel bobbins 46, 47. In other words, the winding diameter at the vicinity of the ends of the body 101 and at the vicinity of its middle section, which are altered due to the pivoting of the dancer arms 57, 58, are compared. The form of the winding near the tapered surface 144 becomes uneven. Thus, as shown in FIGS. 21 and 22, the wire may stick out from the bundle or fall into the bundle along the tapered surface 144. This alters the traveling velocity and tension of the wire during cutting.

Normally, when the wire 37 is wound in an even manner as shown in FIG. 19, unwinding and winding are performed while the reversing position of the traverser 143 is gradually compensated in step 704.

However, when the traveling velocity of the wire 37 becomes fast in step 705, fluctuation of the wire tension, caused by the displacement of the dancer arms 57, 58 is detected, the wire near the tapered surface 144 sticks out as shown in FIG. 21, and the winding diameter at the winding end thus becomes larger than the winding diameter at the middle section. Then, in step 706, the normal compensation of the reversing position, or the extension of the reversed position, is stopped. Thus, the wire 37 is wound by reversing the traverse at a reversing position that is the same as the previous reversing position. This enables the form of the winding to be returned to an even state as shown in FIG. 19. When the form of the winding is recovered and the two diameters described above become equal, the movement of the traverser 143 is returned to normal and the wire 37 is wound by performing the normal reversing position compensation.

On the other hand, when the traveling velocity of the wire becomes slow in step 707, fluctuation of the wire tension, caused by the displacement of the dancer arms 57, 58, is detected, the wire near the tapered surface 144 falls into the bundle along the tapered surface 144 as shown in FIG. 22, and the winding diameter at the winding end becomes smaller than the winding diameter at the middle section. Then, in step 708, the extending distance ΔL of the normal reversed position compensation is further increased. For example, the extended distance may be multiplied by K times. By winding the wire 37 in this state through the reciprocating traversing, the winding form is returned to the even state as shown in FIG. 19. When the form of the winding is recovered and the two diameters described above become equal, the movement of the traverser 143 is returned to normal and the wire 37 is wound by performing the normal reversing position compensation. Accordingly, a winding shape compensating device is composed of the controlling device 120, the magnetic sensor 140, the magnet 141, etc.

Since the wire 37 is wound about the reel bobbins 46, 47 by repeating the sequential processes, the winding shape of the wire 37 is readily compensated regardless of the winding form becoming uneven, and the wire 37 is thus wound about the tapered surface 144 in an even manner like the body 101.

In the third embodiment, the flanges 102, 103 of both reel bobbins 46, 47 are tapered. Therefore, the strength of the flanges 102, 103 is increased and the winding pressure is dispersed by the tapered surface 144. Thus, the possibility of the tension of the wire 37 causing deformation of the flanges 102, 103 is small.

Although several embodiments of the present invention have been described herein, it should be apparent to those skilled in the art that the present invention may be embodied in many other specific forms without departing from the spirit or scope of the invention. For example, the angle θ of the tapered surface 144 may be changed to an angle that differs from the above embodiment. The tapered surface may be formed on only the upper flange 102 instead of both flanges 102, 103. In the above description, two rollers 33, 34 were used. However, more than three rollers may be used.

1. A wire saw for cutting a workpiece by moving the wire lengthwise, the saw comprising:
a first reel bobbin having an axis of rotation;
a second reel bobbin having an axis of rotation;
a strand of wire connected to the bobbins, wherein the wire is wrapped about the first bobbin and is connected to the second bobbin such that the wire is unwound from the first bobbin and is wound about the second bobbin;
a plurality of cutting rollers about which the wire is wrapped;
a bobbin support for supporting each bobbin such that each bobbin is rotatable about its axis and such that the weight of each bobbin acts only in the axial direction;
a rotatable shaft, the axis of which is aligned with the axis of the associated bobbin; and
a flange connected to an upper end of the rotatable shaft for supporting the associated bobbin, wherein a lower end of the associated bobbin is connected to an upper end of the flange so that rotation of the rotatable shaft is transmitted to the associated bobbin and the associated bobbin is readily removable from the flange;
a pair of motors, one being connected to each bobbin for rotating the bobbins individually; and
a controller for controlling the rotating speed of each motor in accordance with the wire winding diameter of at least one of the bobbins such that the wire is moved at a predetermined speed.

2. The wire saw according to claim 1, wherein the top of each bobbin is urged downward by a spring and wherein the spring allows the bobbin to expand and contract axially while being firmly held.

3. The wire saw according to claim 1, wherein at least one of the bobbins has a flange formed at each of its two ends for confining the wire, and wherein each flange is tapered.

4. A wire saw according to claim 1 further comprising a traverser associated with at least one of the bobbins for guiding the unwinding and winding of the wire, said traverser being constructed to reverse direction such that it travels back and forth in the axial direction of the associated bobbin.

5. A wire saw according to claim 4 further comprising a controller for controlling a drive means of the traverser in correspondence with a program such that the traverser reverses direction and travels back and forth between reversing directions.

6. A wire saw according to claim 5 further comprising:
a sensor for detecting the inclination of the wire extending between the traverser and the associated bobbin and transmitting a signal when the inclination is abnormal; and
means for adjusting the traveling speed of the traverser so as to incline the wire extending between the traverser and the associated bobbin to a normal angle.

7. A wire saw according to claim 6 including a means for adjusting at least one of the positions of the traverser when it reverses direction so that the wire is wound uniformly.

8. A wire saw according to claim 7 including a sensor for detecting an upper limit position of the traverser with respect to the associated bobbin.

9. A wire saw according to claim 4 including a controller for controlling the position at which the traverser reverses direction such that the controller compares the winding diameter in the vicinity of the middle of the second bobbin with the winding diameter at an end of the second bobbin and adjusts the reversing position to maintain uniform winding of the wire on the second bobbin.

10. The wire saw according to claim 1 further comprising:
a displacement device, which is displaced in accordance with the tension of the wire to apply a constant tension to the wire, and
a sensor, which detects the position of the displacement device.

11. The wire saw according to claim 10 further comprising:
a braking device associated with each bobbin for braking the rotation of the associated bobbin in response to detection by the sensor of the displacement device being in a predetermined position.

12. A method for controlling a wire saw that cuts a workpiece by moving the wire lengthwise, the saw having a first reel bobbin having an axis of rotation; a second reel bobbin having an axis of rotation; a strand of wire connected to the bobbins such that the wire is wrapped about the first bobbin and is connected to the second bobbin, and the wire is unwound from the first bobbin and is wound about the second bobbin; a plurality of cutting rollers about which the wire is wrapped; a bobbin support for supporting each bobbin such that each bobbin is rotatable about its axis, the method comprising the steps of:
arranging the axes of the bobbins such that the weight of the bobbins and the wire wound thereon acts in the axial direction of each bobbin; and
guiding the wire as it is wound onto the second bobbin to cause the wire to be wound uniformly with a traverser that reverses to move back and forth between reversing positions in the axial direction of the second bobbin in correspondence with a program.

13. A method according to claim 12 including the steps of detecting the inclination of the wire extending between the traverser and the associated bobbin and adjusting the traveling speed of the traverser so as to incline the wire extending between the traverser and the associated bobbin to a normal angle when an abnormal angle is detected in the detecting step.

14. A method according to claim 12 including the step of periodically adjusting at least one reversing position of the traverser to assure uniform winding of wire on the second bobbin.

15. A method according to claim 14 including the steps of sensing an outer limit position of the traverser with respect to the second bobbin with a sensor and moving the traverser to the outer limit position before reversing it every predetermined number of reversals in order to wind the wire in a uniform manner.

16. A method according to claim 12 including the step of sensing the position of the traverser with respect to the second bobbin with a sensor.

17. A method according to claim 12 including the step of gradually increasing the distance the traverser moves between reversals by gradually moving the reversing positions toward the ends of the second bobbin.

18. A method according to claim 12 including the steps of:
judging the winding diameter of the bobbin in the vicinity of the middle of the bobbin and in the vicinity of the ends of the bobbin; and
adjusting the reversing positions of the traverser in accordance with the winding diameters to achieve a uniform winding on the second bobbin.

19. A method for controlling a wire saw that cuts a workpiece by moving the wire lengthwise, the saw having a first reel bobbin having an axis of rotation; a second reel bobbin having an axis of rotation; a strand of wire connected to the bobbins such that the wire is wrapped about the first bobbin and is connected to the second bobbin, and the wire is unwound from the first bobbin and is wound about the second bobbin; a plurality of cutting rollers about which the wire is wrapped; a bobbin support for supporting each bobbin such that each bobbin is rotatable about its axis, the method comprising the step of arranging the axes of the bobbins such that the weight of the bobbins and the wire wound thereon acts in the axial direction of each bobbin;
reading the traveling speed of the wire and the initial winding diameter of each bobbin; and
controlling the rotational speed of the bobbin in accordance with the change in winding diameter compared to the initial winding diameter so as to adjust the traveling speed of the wire.

20. A method according to claim 19 further including the steps of:
sensing changes in the tension of the wire at a point on the wire's path located between the first and second bobbins by detecting the position of a displacement device which is displaced in accordance with the tension of the wire to apply a constant tension to the wire; and
altering the rotational speed of at least one of the bobbins to suppress changes in the tension of the wire sensed in the last step.
